(19) United States
(12) Patent Application Publication
(10) Pub. No.: US 2009/0057585 A1
(43) Pub. Date: Mar. 5, 2009

(54) Device for Controlling the Supply of a Fuel Gas in Internal Combustion Engines

(75) Inventors: Morgan Giraldo, Codevigo (IT); Giuseppe Veronese, Montegrotto Terme (IT)

Correspondence Address: CASTELLANO PLLC, P.O. Box 1555, Great Falls, VA, 22066, US

(73) Assignee: OMVL S.P.A., Pernumia (PD) (IT)

(21) Appl. No.: 12/295,989

(22) PCT Filed: Apr. 3, 2007
(86) PCT No.: PCT/EP2007/002973

§ 371 Date: Oct. 3, 2008

(30) Foreign Application Priority Data
Apr. 5, 2006 (IT) PD2006A000126

(51) Int. Cl. F16K 31/04

(52) U.S. Cl. 251/129.01

(57) ABSTRACT

A device for controlling the supply of fuel gas in internal combustion engines (2) comprises a gas supply duct (4) and valve means provided in this duct in order to intercept the flow of fuel gas to a combustion chamber of the engine (2), in which the valve means comprise at least one electrovalve (6) controlled by a manually actuated electromagnet (7).

### TECHNICAL FIELD

The present invention relates to a device for controlling the supply of fuel gas in internal combustion engines, having the characteristic features set out in the preamble of the main claim.

### TECHNOLOGICAL BACKGROUND

The invention is of particular, but not exclusive, application in the particular sector of relatively low-power internal combustion engines supplied with fuel gas, for instance liquefied petroleum gas (LPG) or methane.

Typical applications are, for instance, in engines for two- or three-wheel vehicles, and in low-power gardening equipment and marine engines. It will nevertheless be appreciated that the invention could also be applied to dual-fuel engines, for instance designed to be supplied alternatively with petrol and fuel gas, or to engines designed to be supplied with petrol and subsequently converted so that they can as an alternative be supplied with fuel gas.

In this particular field, it is necessary to provide valve means to intercept the flow of gas supplied from the tank to the combustion chamber of the engine which are adapted to open the flow of gas on ignition of the engine and, vice versa, to intercept the flow when the engine is switched off.

One possible solution would to be provide, as valve means, electromagnetically controlled electrovalves of conventional type which nevertheless require control powers of a certain size (even in the range of some watts) in order to exert the forces required to open the shutter of the electrovalve. Such powers are generally not available in engine arrangements of the type described above. In practice, these particular applications are not normally provided with auxiliary electrical energy accumulators or electrical energy generation devices of a power able to supply the electrovalve. In practice, they are originally designed and constructed to function with liquid fuel without the provision of an interception electrovalve. Such accumulators or auxiliary electrical energy generation systems are not in general provided both because of the costs that they entail and because they tend to discharge over time (in the case of accumulators) and may compromise the operation of the engine when it is used irregularly, and also require maintenance operations and costs that are not justified in these applications. It should also be borne in mind that the environment in which the engine is used (for instance the marine environment) may compromise its operation with the result that its use is not therefore advisable.

In this field, therefore, where only the energy generated by a dynamo-electric generator, actuated by the engine, is available, the electromagnetically controlled electrovalves mentioned above are not therefore suitable as a result of the powers and energies needed and cannot be used for the required functions.

### DISCLOSURE OF THE INVENTION

The problem underlying the present invention is that of providing a control device for the supply of fuel gas in internal combustion engines which is structurally and functionally designed to remedy the drawbacks discussed with reference to the cited prior art.

This problem is resolved by the invention by means of a device embodied in accordance with the accompanying claims.

### BRIEF DESCRIPTION OF THE DRAWINGS

The characteristic features and advantages of the invention are set out in further detail in the following description of a preferred embodiment thereof shown, by way of non-limiting example, in the accompanying drawings, in which:

FIG. 1 is a diagrammatic view of a device for controlling the supply of fuel gas to an internal combustion engine in accordance with the invention;

FIG. 2 is a view in axial section of a detail of the device of FIG. 1;

FIGS. 3A and 3B are diagrammatic views corresponding to FIG. 1 of various variants of the invention.

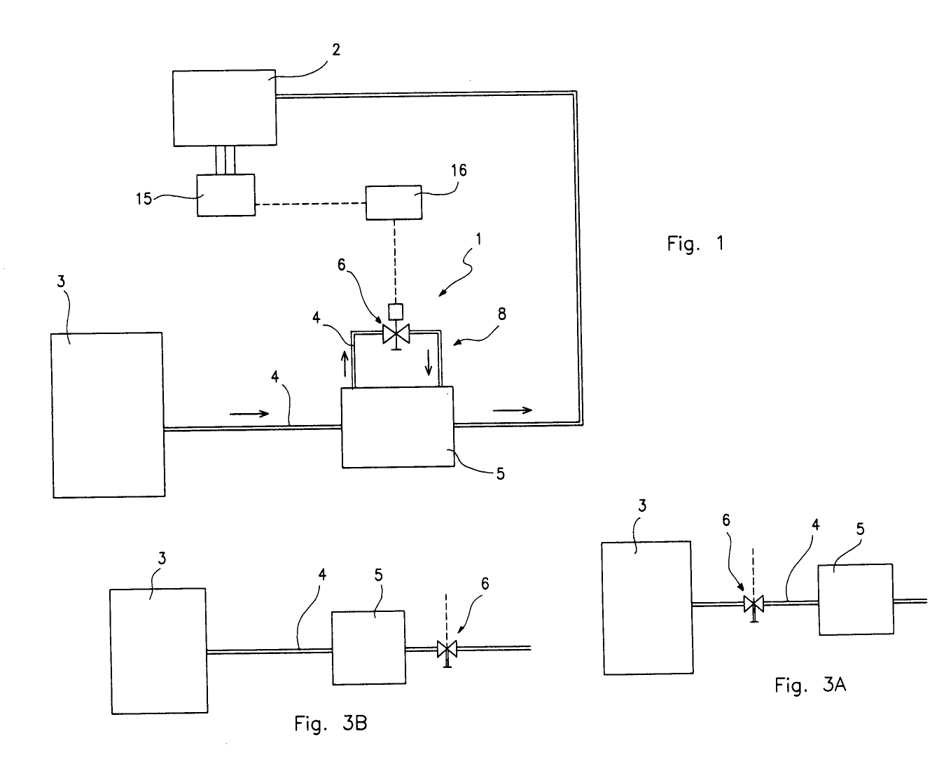

### PREFERRED EMBODIMENT OF THE INVENTION

In the accompanying drawings, a device for controlling the supply of fuel gas in an internal combustion engine 2, shown diagrammatically in the drawings, is shown overall by 1.

The engine 2 is adapted to be supplied by fuel gas, for instance liquefied petroleum gas (LPG) or as an alternative methane gas, although it will be appreciated that the device of the invention could in principle be applied to engines supplied with other gaseous fuels.

The engine 2 is also of the type with pull start ignition, in which ignition takes place by rotation effected from outside the drive shaft. Engines of this type, normally of low power, are used for instance in the marine sector for small craft. As a result of its nature, this type of engine does not therefore require an accumulator such as the battery typically provided in the motor vehicle sector, or an auxiliary energy generator adapted to supply the energy needed to supply a power electrovalve in addition to that required for the ignition of the engine.

The gas is supplied to the engine 2 from a tank 3 via a supply duct 4 in which a pressure reducer/regulator 5 is provided and is adapted to bring the pressure at which the gas is supplied to the combustion chamber of the engine to values in keeping with the operation and efficiency required from the engine and to maintain it at those values.

The device 1, as will be described below, is characterised in that it comprises a main circuit and a drive circuit, wherein the latter may comprise valve means to intercept the flow of fuel gas supplied along the duct 4 to the combustion chamber of the engine.

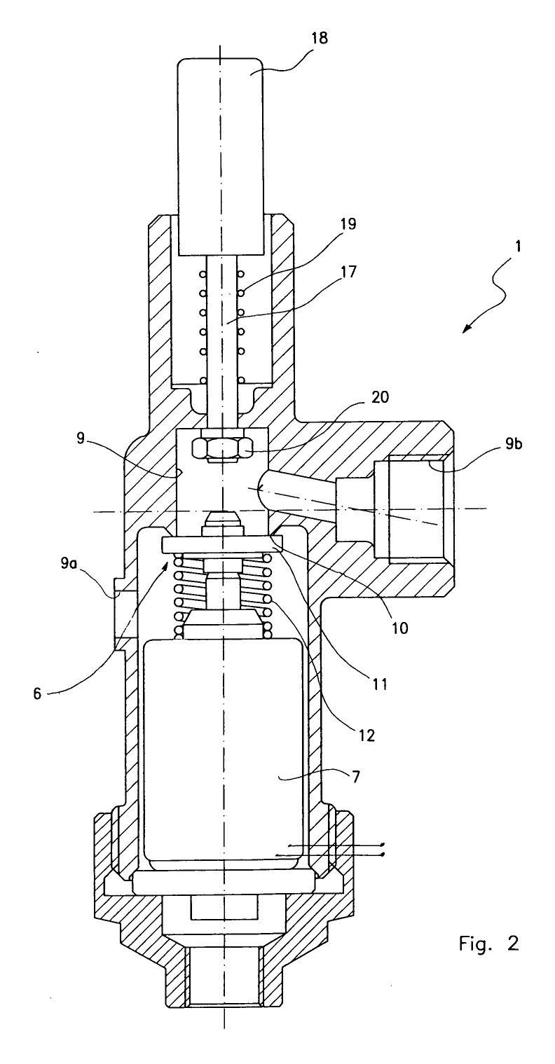

According to a main characteristic feature of the invention, the valve interception means comprise an electrovalve, shown overall by 6, controlled by an electromagnet 7 (FIG. 2) which is manually actuated, as will be described in further detail below.

The electrovalve 6 is preferably provided in a drive circuit 8 of a servo-valve provided in the pressure reducer 5, although it will be appreciated that it could as an alternative be appropriately dimensioned and disposed in the main gas supply duct upstream (FIG. 3A) or downstream (3B) of the pressure reducer. The arrangement of the electrovalve 6 in the drive circuit offers the advantage of requiring relatively small retaining forces, working with smaller gas flows and passage sections than those provided in the main supply duct.

More particularly, the electrovalve 6 comprises a valve body in which a gas passage 9 is defined between an intake opening 9a and a discharge opening 9b, and in which a valve seat 10 associated with a shutter 11 is provided.

The shutter 11 is urged to close on the seat by a spring 12, coaxial therewith, and is also held, in opposition to the spring 12, in the open position of the seat by the action of magnetic attraction generated by the electromagnet 7. The latter comprises an electrical coil supplied by the current from a dynamo-electric generator 15 which is caused to rotate by the engine 2. A current rectifier is shown by 16 and is interposed in the electrical supply line between the dynamo and the coil, in order appropriately to supply the latter with direct current.

As mentioned above, a main prerogative of the electrovalve 6 lies in its manual actuation which is obtained by means of an operating rod 17 mounted coaxially with respect to the shutter of the valve body and able to displace the shutter, when the magnetic unit is actuated, in opposition to the spring, by means of a push-button control 18 which may be manually depressed by the user. A recall spring is also shown by 19 and recalls the push button 18 into the rest position once the stroke to actuate the magnetic unit has taken place. A nut 20 is screwed on the end of the rod 17 opposite the push button in order to hold the rod on the valve body, as shown in detail in FIG. 3.

The manual actuating member of the magnetic unit may comprise a remote control device either of the insulated wire type or with a rigid or articulated rod or with a cam or a combination of these systems, adapted to displace the shutter away from the valve seat, in opposition to the resilient means, when the magnetic unit is actuated, in order to enable the gas to flow to the combustion chamber of the engine.

In operation, for the ignition of the engine, the user acts on the push button 18 of the electrovalve and, keeping the latter depressed so as to open the flow of gas to the combustion chamber, at the same time acts on the pull start ignition of the engine. Once the engine is started, the dynamo is caused to rotate by the drive shaft thus supplying the electrical current needed to supply the electromagnet of the electrovalve and thus ensuring the electromagnetic action needed to hold the shutter in the open position of the valve seat. It will be appreciated that when the engine is switched off, as no current is generated by the dynamo, the electrical supply of the coil is discontinued and the shutter is recalled by the spring 12 into the position closing the valve seat, thereby intercepting the flow of gas.

It will be appreciated that, as the electrovalve is manually actuated, the electromagnet solely has to provide the power needed to hold the shutter (in the attracted position) and not the power needed to pull the shutter; this holding power may be of the order of a few milliwatts in comparison with pulling powers which may in contrast be of the order of some watts. In this way, the reduced power required from the electromagnet may be obtained from the energy generated by the dynamo-electric device actuated by the engine, without therefore requiring any auxiliary energy generator or battery of any type and without impacting on the pulling force on ignition; the addition of auxiliary devices to generate electrical energy of a power able to actuate the electromagnetically opened valve would in contrast increase the pulling force, making ignition critical. The fact that there is no need to provide auxiliary generators or energy accumulators makes the application of the invention particularly advantageous in low-power engines, of the type mentioned above, both because of the overall cost saving and because of the structural simplification and adequate reliability of operation obtained.

The invention thus resolves the problem set out above and achieves the advantages set out with respect to known solutions.

1. A device for controlling the supply of fuel gas in internal combustion engines, comprising a gas supply duct and valve means provided in the duct in order to intercept flow of fuel gas to a combustion chamber of the engine, wherein the valve means comprise at least one electrovalve controlled by a manually actuated electromagnet.

2. A device according to claim 1, wherein the electromagnet comprises a coil electrically supplied with current from a dynamo-electric generator actuated by rotation of the engine.

3. A device according to claim 2, wherein the electrovalve comprises a shutter associated with a respective valve seat, the shutter being urged by resilient means to close the seat and being held, in opposition to the resilient means, in an open position of the valve seat by magnetic attraction generated by the electromagnet following the electrical supply of the coil of this unit.

4. A device according to claim 3, comprising a manual actuating member of the magnetic unit comprising an operating rod adapted to displace the shutter away from the valve seat, in opposition to the resilient means, when the magnetic unit is actuated so as to enable the gas to flow to the combustion chamber of the engine.

5. A device according to claim 4, wherein the operating rod is connected to a push-button control member in order to cause manual actuation of the magnetic unit.

6. A device according to claim 1, wherein the electrovalve is provided in a drive circuit of a servo-valve of a pressure reducer disposed upstream of the combustion chamber of the engine.

7. A device according to claim 2, wherein a current rectifier device is disposed between the dynamo-electric generator and the electrovalve in order to supply the electrovalve with direct current.

8. A device according to claim 3, comprising a manual actuating member of the magnetic unit comprising a remote control device selected from the group consisting of a remote control device of an insulated wire type, a remote control device with a rigid or articulated rod, and a remote control device with a cam, adapted to displace the shutter away from the valve seat, in opposition to the resilient means, when the magnetic unit is actuated so as to enable the gas to flow to the combustion chamber of the engine.
